(19) United States
(12) Patent Application Publication
(10) Pub. No.: US 2024/0340823 A1
(43) Pub. Date: Oct. 10, 2024

(54) SIDELINK SYNCHRONIZATION SIGNAL BLOCK REPETITION IN WIDEBAND COMMUNICATIONS

(71) Applicant: QUALCOMM Incorporated, San Diego, CA (US)

(72) Inventors: Chih-Hao LIU, San Diego, CA (US); Giovanni CHISCI, San Diego, CA (US); Jing SUN, San Diego, CA (US); Xiaoxia ZHANG, San Diego, CA (US); Peter GAAL, San Diego, CA (US)

(21) Appl. No.: 18/610,684

(22) Filed: Mar. 20, 2024

Related U.S. Application Data
(60) Provisional application No. 63/494,879, filed on Apr. 7, 2023.

(51) Int. Cl. H04W 56/00; H04J 13/00; H04W 92/18

(52) U.S. Cl. CPC H04W 56/0015; H04J 13/0025; H04J 13/0029; H04W 92/18

(57) ABSTRACT

Wireless communications systems, apparatuses, and methods are provided. A method of wireless communication performed by a first user equipment (UE) includes transmitting, to a second UE, a first sidelink synchronization block (S-SSB) in a first subset of a bandwidth, wherein the first S-SSB comprises a first sequence shift and a first identifier associated with the first UE and transmitting, to the second UE, one or more additional S-SSBs in one or more additional subsets of the bandwidth, wherein the one or more additional S-SSBs comprises at least one of a second sequence shift different from the first sequence shift or a second identifier associated with the first UE different from the first identifier associated with the first UE.

### CROSS-REFERENCE TO RELATED APPLICATIONS

The present application claims the benefit of, and priority to, U.S. Provisional Patent Application No. 63/494,879, filed Apr. 7, 2023, the entirety of which is incorporated by reference herein.

### TECHNICAL FIELD

This application relates to wireless communication systems, and more particularly, to sidelink synchronization signal block repetition in wideband communications over unlicensed spectrum.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first user equipment (UE), may include transmitting, to a second UE, a first sidelink synchronization block (S-SSB) in a first subset of a bandwidth, wherein the first S-SSB comprises a first sequence shift and a first identifier associated with the first UE and transmitting, to the second UE, one or more additional S-SSBs in one or more additional subsets of the bandwidth, wherein the one or more additional S-SSBs comprises at least one of a second sequence shift different from the first sequence shift or a second identifier associated with the first UE different from the first identifier associated with the first UE.

In an additional aspect of the disclosure, a method of wireless communication performed by a first user equipment (UE) may include receiving, from a second UE, a first sidelink synchronization block (S-SSB) in a first subset of a bandwidth, wherein the first S-SSB comprises a first sequence shift and a first identifier associated with the second UE and receiving, from the second UE, one or more additional S-SSBs in one or more additional subsets of the bandwidth, wherein the one or more additional S-SSBs comprises at least one of a second sequence shift different from the first sequence shift or a second identifier associated with the second UE different from the first identifier associated with the second UE.

In an additional aspect of the disclosure, a first user equipment (UE) may include a memory; a transceiver; and at least one processor coupled to the memory and the transceiver, wherein the first UE is configured to transmit, to a second UE, a first sidelink synchronization block (S-SSB) in a first subset of a bandwidth, wherein the first S-SSB comprises a first sequence shift and a first identifier associated with the first UE and transmit, to the second UE, one or more additional S-SSBs in one or more additional subsets of the bandwidth, wherein the one or more additional S-SSBs comprises at least one of a second sequence shift different from the first sequence shift or a second identifier associated with the first UE different from the first identifier associated with the first UE.

In an additional aspect of the disclosure, a first user equipment (UE) may include a memory; a transceiver; and at least one processor coupled to the memory and the transceiver, wherein the first UE is configured to receive, from a second UE, a first sidelink synchronization block (S-SSB) in a first subset of a bandwidth, wherein the first S-SSB comprises a first sequence shift and a first identifier associated with the second UE and receive, from the second UE, one or more additional S-SSBs in one or more additional subsets of the bandwidth, wherein the one or more additional S-SSBs comprises at least one of a second sequence shift different from the first sequence shift or a second identifier associated with the second UE different from the first identifier associated with the second UE.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates multiple S-SSB repetitions in a wide bandwidth according to some aspects of the present disclosure.

FIG. 4 is a signal flow diagram for multiple S-SSB transmissions according to some aspects of the present disclosure.

FIG. 5 is a signal flow diagram for multiple S-SSB transmissions according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHZ BW. For other various indoor wideband implementations, using a TDD over the unlicensed portion of the 5 GHz band, the subcarrier spacing may occur with 60 KHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (Rus)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

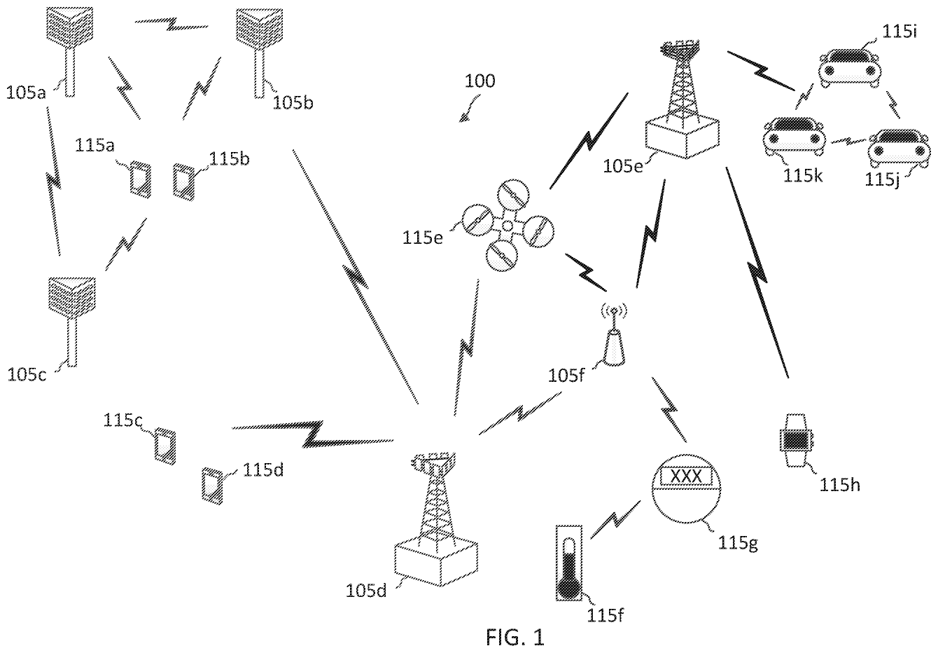

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115c-115h are examples of various machines configured for communication that access the network 100. The UEs 115l-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115c may include links from the macro BSs 105d and 105c, as well as links from the small cell BS 105f. Other machine type devices, such as the UE 115f (e.g., a thermometer), the UE 115g (e.g., smart meter), and UE 115h (e.g., wearable device) may communicate through the network 100 cither directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115j may transmit a first sidelink synchronization block (S-SSB) to the UE 115k in a first subset of a bandwidth, wherein the first S-SSB comprises a first sequence shift and a first identifier associated with the UE 115j. The UE 115j may transmit one or more additional S-SSBs to the UE 115k in one or more additional subsets of the bandwidth. In some aspects, the one or more additional S-SSBs may comprise at least one of a second sequence shift different from the first sequence shift or a second identifier associated with the UE 115j different from the first identifier associated with the UE 115j.

In some aspects, the UE 115k may receive a first sidelink synchronization block (S-SSB) from the UE 115j in a first subset of a bandwidth, wherein the first S-SSB comprises a first sequence shift and a first identifier associated with the UE 115j. The UE 115k may receive one or more additional S-SSBs from the UE 115j in one or more additional subsets of the bandwidth. In some aspects, the one or more additional S-SSBs may comprise at least one of a second sequence shift different from the first sequence shift or a second identifier associated with the UE 115j different from the first identifier associated with the UE 115j.

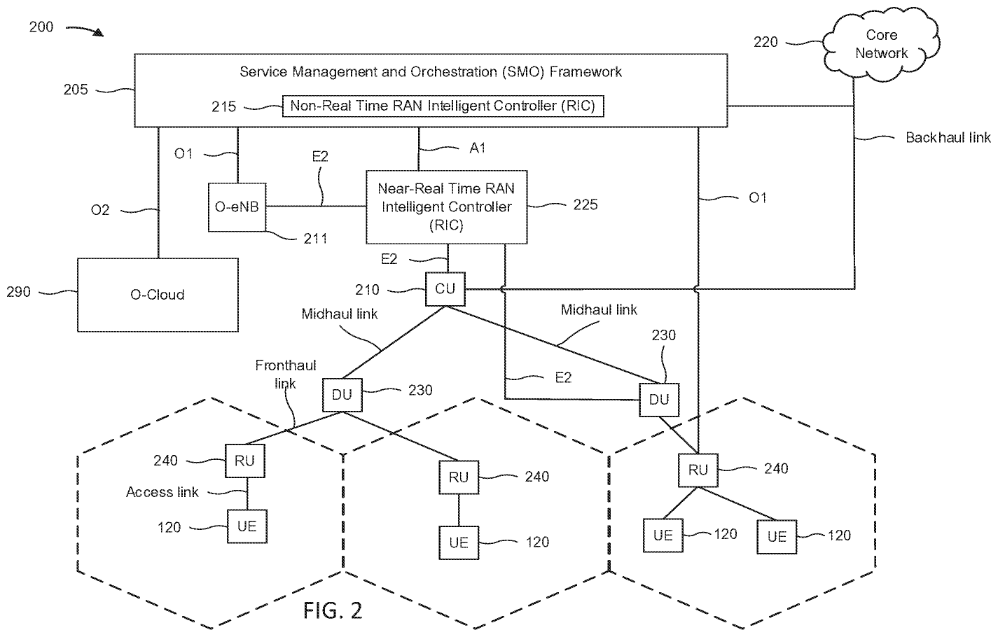

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

In some aspects, a first UE 115 may transmit a first sidelink synchronization block (S-SSB) to a second UE 115 in a first subset of a bandwidth, wherein the first S-SSB comprises a first sequence shift and a first identifier associated with the first UE 115. The first UE 115 may transmit one or more additional S-SSBs to the second UE 115 in one or more additional subsets of the bandwidth. In some aspects, the one or more additional S-SSBs may comprise at least one of a second sequence shift different from the first sequence shift or a second identifier associated with the first UE 115 different from the first identifier associated with the first UE 115.

In some aspects, a first UE 115 may receive a first sidelink synchronization block (S-SSB) from a second UE 115 in a first subset of a bandwidth, wherein the first S-SSB comprises a first sequence shift and a first identifier associated with the second UE 115. The first UE 115 may receive one or more additional S-SSBs from the second UE 115 in one or more additional subsets of the bandwidth. In some aspects, the one or more additional S-SSBs may comprise at least one of a second sequence shift different from the first sequence shift or a second identifier associated with the second UE 115 different from the first identifier associated with the second UE 115.

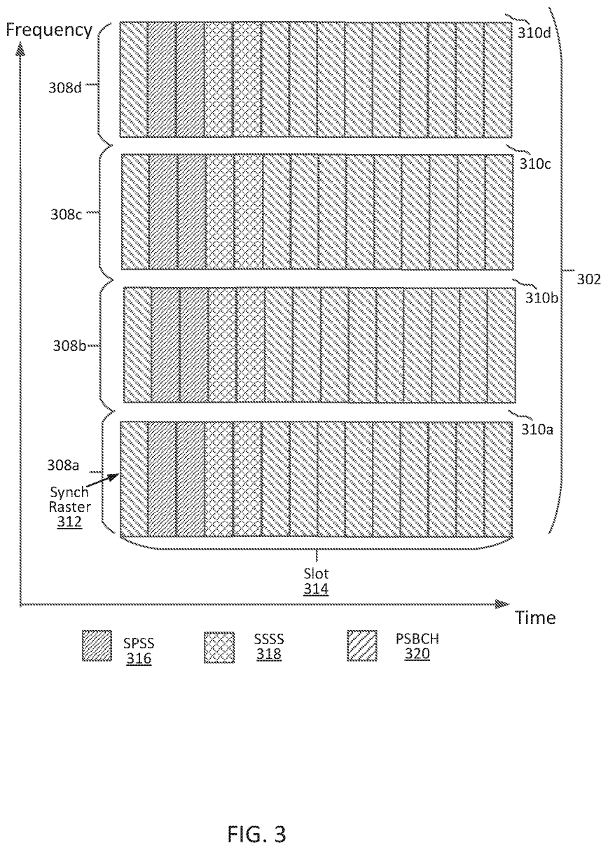

FIG. 3 illustrates resources for multiple S-SSB transmission in a bandwidth 302 according to some aspects of the present disclosure. In some aspects, a first UE (e.g., the UE 115 or the UE 600) may transmit a first sidelink synchronization block (S-SSB) to a second UE (e.g., the UE 115 or the UE 600) in slot 314. In this regard, the first UE may transmit the first S-SSB to the second UE in a first subset 308a of bandwidth 302. The bandwidth 302 may include a 20 MHz bandwidth, a 40 MHz bandwidth, an 80 MHZ bandwidth, or other suitable bandwidth. In some aspects, the bandwidth 302 may be in an unlicensed band (e.g., a shared band). The subset 308 of the bandwidth 302 may include a 5 MHz bandwidth part, a 10 MHz bandwidth part, or any suitable bandwidth part. The first S-SSB may include a sidelink primary synchronization signal (SPSS) 316, a sidelink secondary synchronization signal (SSSS) 318, and a physical sidelink broadcast channel (PSBCH) 320. The first UE may be a sidelink syncref UE. The second UE may decode the S-SSB to determine a sidelink synchronization identity associated with the first UE and synchronize timing to the first UE. In some aspects, there may be 672 unique physical layer sidelink synchronization identities for the first UE given by N_{ID}^{SL}=N_{ID,1}^{SL}+336N_{ID,2}^{SL}, where N_{ID,1}^{SL}∈{0,1, . . . ,335} and N_{ID,2}^{SL}∈{0,1}.

In some aspects, the first UE may transmit one or more additional S-SSBs in one or more additional subsets 308 of the bandwidth 302 to the second UE. In this regard, the first UE may transmit one, two, three, or more additional S-SSB(s) in one or more additional subsets 308 of the bandwidth 302. For example, the first UE may transmit additional S-SSBs in subsets 308b, 308c, and 308d of the bandwidth 302. Although FIG. 3 shows four S-SSBs transmitted in four frequency subsets 308, the present disclosure is not so limited and any number of S-SSBs may be transmitted over the bandwidth 302.

In some aspects, repeating the transmission of additional S-SSBs in subsets 308b, 308c, and 308d may be associated with a peak-to-average power ratio (PAPR) that may be higher than in other approaches (e.g., due to the repetition of signaling in subsets 308b, 308c, and 308d). In order to reduce the PAPR, the additional S-SSB(s) in subsets 308b, 308c, and 308d may include a second sequence shift different from the first sequence shift and/or a second identifier associated with the first UE different from the first identifier associated with the first UE. In some aspects, the additional subset(s) 308b, 308c, and 308d of the bandwidth may be bandwidth part(s) (e.g., 5 MHZ bandwidth part(s)) located anywhere in the bandwidth 302 other than the first subset 308a of the bandwidth 302. For example, the first subset 308a may be a bandwidth part located at a lower portion of the bandwidth 302 while the additional subset(s) 308b, 308c, and 308d may be located higher than the first subset 308a. The first subset 308a and the additional subset(s) 308b, 308c, and 308d may not overlap in frequency. In some aspects, the first subset 308a of the bandwidth 302 may overlap a first sync raster 312 of the bandwidth 302 and the additional subset(s) 308b, 308c, and 308d of the bandwidth 302 may not overlap additional sync raster(s) of the bandwidth 302. In some aspects, the first subset 308a and the additional subsets 308b, 308c, and 308d may be equally spaced within the bandwidth 302. In some aspects, the subsets 308 of the bandwidth 302 may include one or more guard bands 310. The guard band 310a may be located between the first subset 308a and the additional subset 308b. In some aspects, the first UE may transmit the additional S-SSB(s) in additional subset(s) 308 of the bandwidth 302 in order to occupy the bandwidth 302 and satisfy an occupied channel bandwidth (OCB) requirement (e.g., 80% of a 20 MHz band).

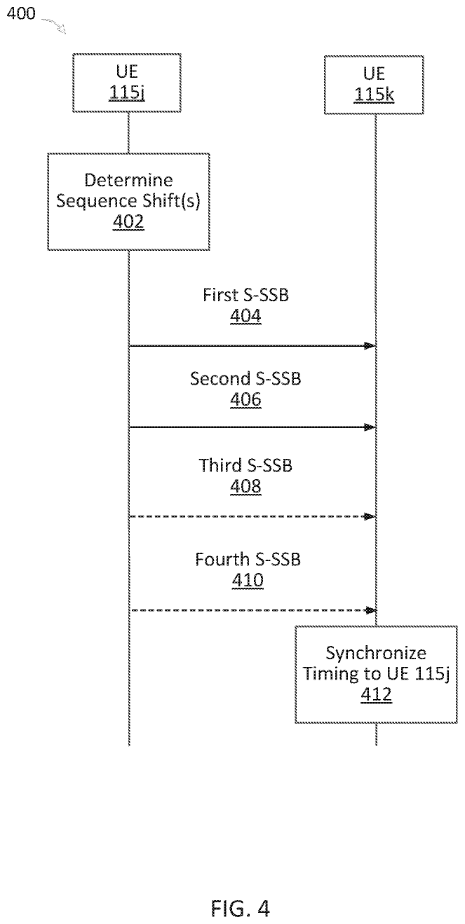

FIG. 4 is a signaling diagram of a wireless communication method 400 according to some aspects of the present disclosure. Actions of the communication method 400 can be executed by a computing device (e.g., a processor, processing circuit, and/or other suitable component) of a communication device or other suitable means for performing the actions. For example, a wireless communication device, such as the UE 115 or UE 600, may utilize one or more components, such as the processor 602, the memory 604, the S-SSB repetition module 608, the transceiver 610, the modem 612, and the one or more antennas 616, to execute aspects of method 400.

At action 402, the UE 115j may determine a sequence shift associated with transmitting S-SSBs to the UE 115k. The UE 115j may determine a sequence shift for transmitting S-SSBs across a bandwidth to the UE 115k in order to reduce a PAPR associated with the repeated S-SSB transmissions. The S-SSBs may each include a sidelink primary synchronization signal (SPSS), a sidelink secondary synchronization signal (SSSS), and a physical sidelink broadcast channel (PSBCH). The UE 115j may be a sidelink syncref UE. The UE 115k may decode one or more S-SSBs to determine a sidelink synchronization identity associated with the UE 115j and synchronize timing to the UE 115j. In some aspects, there may be 672 unique physical layer sidelink synchronization identities for the UE 115j given by N_{ID}^{SL}=N_{ID,1}^{SL}+336N_{ID,2}^{SL}, where N_{ID,1}^{SL}∈{0,1, . . . ,335} and N_{ID,2}^{SL}∈{0,1}.

In some aspects, the sequence for the SPSS may include at least one of a Gold sequence or at least one m-sequence. In some aspects, the SPSS may be defined by d_{S-PSS}(n)=1−2x(m), m=(n+22+43N_{ID,2}^{SL}) mod 127 and 0≤n<127, where x(i+7)=(x(i+4)+x(i)) mod 2 and [x(6) x(5) x(4) x(3) x(2) x(1) x(0)]=[1 1 1 0 1 1 0]. In some aspects, the UE 115k may decode the SPSS of the first S-SSB transmitted. The SPSS may indicate one out of two identities (e.g., 0 or 1) for (N_{ID,2}^{SL}) associated with the UE 115j.

In some aspects, the sequence for the SSSS may include at least one of a Gold sequence or at least one m-sequence. In some aspects, the SSSS may be defined by d_{S-SSS}(n)=[1−2x₀((n+m₀) mod 127)] [1−2x₁((n+m₁) mod 127)],

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112 and 0 \leq n < 127 ,$$

where x₀(i+7)=(x₀(i+4)+x₀(i)) mod 2 and x₁(i+7)=(x₁(i+1)+x₁ (i)) mod 2, where:
[x₀(6) x₀(5) x₀(4) x₀(3) x₀(2) x₀(1) x₀(0)]=[0 0 0 0 0 0 1] and [x₁(6) x₁(5) x₁(4) x₁(3) x₁(2) x₁(1) x₁(0)]=[0 0 0 0 0 0 1]

In some aspects, the first S-SSB to be transmitted may include a first sequence shift (e.g., a legacy sequence shift according to 3GPP release 16). The first S-SSB may include a legacy ND to determine the unique physical layer sidelink synchronization identity for the UE 115j.

In some aspects, the UE 115j may determine the additional S-SSB(s) shall include a second sequence shift different from the first sequence shift. In some aspects, the UE 115j may transmit the additional S-SSB(s) in additional subset(s) of the bandwidth based on the additional S-SSB(s) having a second sequence shift different from the first sequence shift used in transmitting the first S-SSB. The UE 115j may transmit the additional S-SSB(s) with the second sequence shift different from the first sequence shift in order to reduce a peak-to-average power ratio (PAPR) associated with transmitting multiple S-SSBs across the bandwidth. In this regard, the first SPSS sequence may include the legacy SPSS sequence, m=(n+22+43N_{ID,2}^{SL}) mod 127. However, for i additional S-SSB(s), the additional SPSSs ith frequency copy, m may be modified to be a function of the ‘i’. For example, m=(n+22+f(i)+43N_{ID,2}^{SL}) mod 127 where 1≤i<N. In some aspects, f(i) may be chosen such that (n+22+f(i)+43N_{ID,2}^{SL}) mod 127 is different from legacy m=(n+22+43N_{ID,2}^{SL})) mod 127. For example, the function f(i) may avoid choosing a multiple of 43.

Additionally or alternatively, the first SSSS sequence may include the legacy SSSS sequence and the additional S-SSB(s) may include a different sequence shift. In this regard, the first SSSS sequence may include the legacy SSSS sequence, d_{S-SSS}(n)=[1−2x₀((n+m₀) mod 127)] [1−2x₁((n+m₁) mod 127)], where

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112.$$

However, for i additional S-SSB(s), the additional SSSSs ith frequency copy, m₀ may be modified to be a function of ‘i’. For example,

$${m}_{0} = 15 ⌊ \frac{{N}_{ID , 1}^{SL}}{112} ⌋ + 5 {N}_{ID , 2}^{SL} + g ( i ) ,$$

where 1≤i<N. In some aspects, g(i) may be chosen such that

$${m}_{0} = 15 ⌊ \frac{{N}_{ID , 1}^{SL}}{112} ⌋ + 5 {N}_{ID , 2}^{SL} + g ( i )$$

is different from legacy

$${m}_{0} = 15 ⌊ \frac{{N}_{ID , 1}^{SL}}{112} ⌋ + 5 {N}_{ID , 2}^{SL} .$$

For example, the function g(i) may avoid choosing a multiple of 5.

At action 404, the UE 115j may transmit a first S-SSB to the UE 115k. In this regard, the UE 115j may transmit the first S-SSB to the UE 115k in a first subset of a bandwidth. The bandwidth may include a 20 MHz bandwidth, a 40 MHz bandwidth, an 80 MHz bandwidth, or other suitable bandwidth. In some aspects, the bandwidth may be in an unlicensed band (e.g., a shared band). The subset of the bandwidth may include a 5 MHz bandwidth part, a 10 MHz bandwidth part, or any suitable bandwidth part.

In some aspects, the first S-SSB may include a first sequence shift (e.g., a legacy sequence shift according to 3GPP release 16). The first S-SSB may include a legacy NIB to determine the unique physical layer sidelink synchronization identity for the UE 115j. The UE 115j may transmit the first S-SSB in a subset of the bandwidth (e.g., a 5 MHz bandwidth part) located at a lower portion (e.g., lower edge) of the bandwidth. In some aspects, the first subset of the bandwidth may overlap a first sync raster of the bandwidth. For example, a center portion of the first subset of the bandwidth may overlap a center portion of the sync raster.

At action 406, the UE 115j may transmit a second S-SSB to the UE 115k. In this regard, the UE115j may transmit the second S-SSB to the UE 115k in a second subset of the bandwidth. In some aspects, the second S-SSB(s) may include a second sequence shift different from the first sequence shift transmitted at action 404.

At action 408, the UE 115j may transmit a third S-SSB to the UE 115k. In this regard, the UE115j may transmit the third S-SSB to the UE 115k in a third subset of the bandwidth. In some aspects, the third S-SSB(s) may include the second sequence shift different from the first sequence shift transmitted at action 404. In some aspects, the third S-SSB(s) may include a third sequence shift different from the second sequence shift transmitted at action 406.

At action 410, the UE 115j may transmit a fourth S-SSB to the UE 115k. In this regard, the UE115j may transmit the fourth S-SSB to the UE 115k in a fourth subset of the bandwidth. In some aspects, the fourth S-SSB(s) may include a fourth sequence shift different from the first sequence shift transmitted at action 404. In some aspects, the fourth S-SSB(s) may include a fourth sequence shift different from the second sequence shift transmitted at action 406. In some aspects, the fourth S-SSB(s) may include a fourth sequence shift different from the first, second, and third sequence shifts transmitted at actions 404, 406, and 408 respectively.

At action 412, the UE 115k may synchronize timing to the UE 115j based on one or more S-SSBs received from the UE 115j.

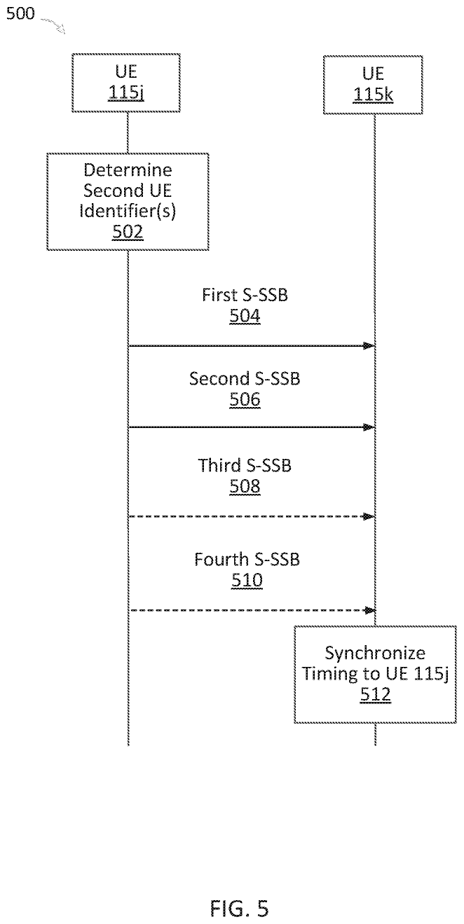

FIG. 5 is a signaling diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115 or UE 600, may utilize one or more components, such as the processor 602, the memory 604, the S-SSB repetition module 608, the transceiver 610, the modem 612, and the one or more antennas 616, to execute aspects of method 500.

At action 502, the UE 115j may determine a second UE identifier associated with transmitting S-SSBs to the UE 115k. The UE 115j may determine a second UE identifier for transmitting S-SSBs across a bandwidth to the UE 115k in order to reduce a PAPR associated with the repeated S-SSB transmissions. The S-SSBs may each include a sidelink primary synchronization signal (SPSS), a sidelink secondary synchronization signal (SSSS), and a physical sidelink broadcast channel (PSBCH). The UE 115j may be a sidelink syncref UE. The UE 115k may decode one or more S-SSBs to determine a sidelink synchronization identity associated with the UE 115j and synchronize timing to the UE 115j. In some aspects, there may be 672 unique physical layer sidelink synchronization identities for the UE 115j given by N_{ID}^{SL}=N_{ID,1}^{SL}+336N_{ID,2}^{SL}, where N_{ID,1}^{SL}∈{0,1, . . . ,335} and N_{ID,2}^{SL}∈{0,1}.

In some aspects, the UE 115j may transmit additional S-SSB(s) in additional subset(s) of the bandwidth based on a second identifier N_{ID,2}^{SL} different from a first identifier N_{ID,2}^{SL} (e.g., legacy identifier) used for transmitting the SPSS in the first S-SSB. For example, in the first S-SSB, the legacy SPSS sequence may be used, m=(n+22+43N_{ID,2}^{SL}) mod 127. However, for i additional S-SSB(s), the additional SPSSs ith frequency copy, a different N_{ID,2}^{SL}(i) is chosen. For example, m=(n+22+43N_{ID,2}^{SL}(i)) mod 127, where N_{ID,2}^{SL}(i)=N_{ID,2}^{SL}+i. Therefore, the unique physical layer sidelink synchronization identity for the UE 115j is given by N=N_{ID,1}^{SL}+336N_{ID,2}^{SL}(i). In this case, the UE 115k receiving the additional SPSSs ith frequency copy(s) would know the value of i and therefore would be able to determine N_{ID,2}^{SL}. In some aspects, i may be an integer offset. For example, if N_{ID,2}^{SL}+i has a value of 1 and i has a value of 1, the second UE would subtract 1 from N_{ID,2}^{SL}+i to determine that N_{ID,2}^{SL} has a value of 0.

Additionally or alternatively, the UE 115j may transmit the additional S-SSB(s) in additional subset(s) of the bandwidth based on a second identifier N_{ID,2}^{SL} different from the first identifier N_{ID,2}^{SL} (e.g., legacy identifier) used for transmitting the SSSS in the first S-SSB. For example, for i additional S-SSB(s), the additional SSSSs ith frequency copy may include a different N_{ID,2}^{SL}(i). For example,

$${m}_{0} = 15 ⌊ \frac{{N}_{ID , 1}^{SL}}{112} ⌋ + 5 {N}_{ID , 2}^{SL} ( i ) ,$$

where 1≤i<N and where N_{ID,2}^{SL}(i)=N_{ID,2}^{SL}+i. Therefore, the unique physical layer sidelink synchronization identity for the UE 115j is given by N_{ID}^{SL}=N_{ID,1}^{SL}+336N_{ID,2}^{SL}(i). In this case, the UE 115k receiving the additional SSSSs ith frequency copy(s) would know the value of i and therefore would be able to determine N_{ID,2}^{SL}. In some aspects, i may be an integer offset. For example, if N_{ID,2}^{SL}i has a value of 1 and i has a value of 1, the second UE would subtract 1 from N_{ID,2}^{SL}+i to determine that N_{ID,2}^{SL} has a value of 0.

Additionally or alternatively, the UE 115j may transmit the additional S-SSB(s) in additional subset(s) of the bandwidth based on a second physical layer sidelink synchronization identity for the UE 115 N_{ID}^{SL} different from the first physical layer sidelink synchronization identity for the UE 115j N_{ID}^{SL} (e.g., the actual UE 115j identifier). For example, a circular shift in x₁(n) and x₀(n) of the SSSS sequence d_{S-SSS}(n)=[1−2x₀((n+m₀) mod 127)] [1−2x₁((n+m₁) mod 127)] may determine the second physical layer sidelink synchronization identity for the UE 115j N_{ID}^{SL}. In some aspects, the UE 115k may decode and combine the first S-SSB and the additional S-SSB(s). In some aspects, the second physical layer sidelink synchronization identity for the UE 115j N_{ID}^{SL} may be an integer offset from the first physical layer sidelink synchronization identity for the UE 115j N_{ID}^{SL} (e.g., the actual UE 115j identifier). In this case, the UE 115k receiving the additional S-SSBs would know the value of the offset and therefore would be able to determine the actual physical layer sidelink synchronization identity for the first UE 115j.

Additionally or alternatively, the UE 115j may transmit the additional S-SSB(s) in additional subset(s) of the bandwidth based on a second physical layer sidelink synchronization identity for the UE 115j N_{ID}^{SL} different from the first physical layer sidelink synchronization identity for the UE 115j N_{ID}^{SL} (e.g., the actual UE 115j identifier). For example, an initialization value (e.g., an initial scrambling seed) for an i-th frequency repetition of the additional S-SSB(s) in additional subset(s) of the bandwidth may be expressed as cᵢₙᵢₜ=ƒ(N_{ID}^{SL}, (i)) (e.g., instead of the unmodified initialization value of cᵢₙᵢₜ=N_{SL}^{ID}). In cases involving modification of the initialization variable for scrambling the additional S-SSB(s), a different N_{ID}^{SL} may result in the sequence shift in x₀ or/and x₁ in the SSSS of the additional S-SSB(s).

At action 504, the UE 115j may transmit a first S-SSB to the UE 115k. In this regard, the UE115j may transmit the first S-SSB to the UE 115k in a first subset of a bandwidth. The bandwidth may include a 20 MHz bandwidth, a 40 MHz bandwidth, an 80 MHz bandwidth, or other suitable bandwidth. In some aspects, the bandwidth may be in an unlicensed band (e.g., a shared band). In some aspects, the first S-SSB may include a legacy N_{ID}^{SL} to determine the unique physical layer sidelink synchronization identity for the UE 115j. The UE 115j may transmit the first S-SSB in a first subset of the bandwidth. The first subset of the bandwidth may be a bandwidth part (e.g., a 5 MHz bandwidth part) located at a lower portion (e.g., lower edge) of the bandwidth. In some aspects, the first subset of the bandwidth may overlap a first sync raster of the bandwidth. For example, a center portion of the first subset of the bandwidth may overlap a center portion of the sync raster.

At action 506, the UE 115j may transmit a second S-SSB to the UE 115k. In this regard, the UE115j may transmit the second S-SSB to the UE 115k in a second subset of the bandwidth. In some aspects, the second S-SSB(s) may include a second identifier associated with the UE 115j different from the first identifier associated with the UE 115j transmitted at action 504.

At action 508, the UE 115j may transmit a third S-SSB to the UE 115k. In this regard, the UE115j may transmit the third S-SSB to the UE 115k in a third subset of the bandwidth. In some aspects, the third S-SSB(s) may include a third identifier associated with the UE 115j different from the first identifier associated with the UE 115j transmitted at action 504. In some aspects, the third S-SSB(s) may include a third identifier different from the second identifier transmitted at action 506.

At action 510, the UE 115j may transmit a fourth S-SSB to the UE 115k. In this regard, the UE115j may transmit the fourth S-SSB to the UE 115k in a fourth subset of the bandwidth. In some aspects, the fourth S-SSB(s) may include a fourth identifier different from the first identifier transmitted at action 504. In some aspects, the fourth S-SSB(s) may include a fourth identifier different from the second identifier transmitted at action 506. In some aspects, the fourth S-SSB(s) may include a fourth identifier different from the first, second, and third identifiers transmitted at actions 504, 506, and 508 respectively.

At action 512, the UE 115k may synchronize timing to the UE 115j based on one or more S-SSBs received from the UE 115j.

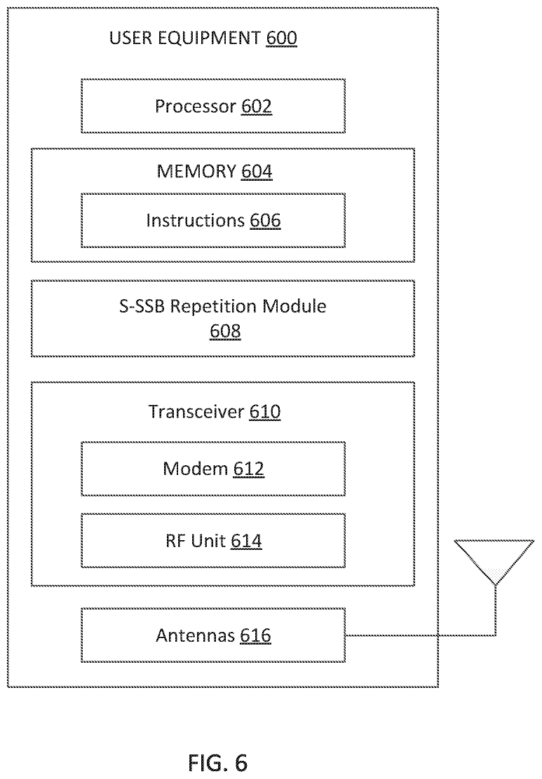

FIG. 6 is a block diagram of an exemplary UE 600 according to some aspects of the present disclosure. The UE 600 may be the UE 115 in the network 100, 200, or 300 as discussed above. As shown, the UE 600 may include a processor 602, a memory 604, a S-SSB repetition module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 3-5. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The S-SSB repetition module 608 may be implemented via hardware, software, or combinations thereof. For example, the S-SSB repetition module 608 may be implemented as a processor, circuit, and/or instructions 606 stored in the memory 604 and executed by the processor 602. In some aspects, the 608 may implement the aspects of FIGS. 3-5. For example, the S-SSB repetition module 608 of a first UE (e.g., the UE 115 or 600) may transmit a first sidelink synchronization block (S-SSB) to a second UE (e.g., the UE 115 or 600) in a first subset of a bandwidth, wherein the first S-SSB comprises a first sequence shift and a first identifier associated with the first UE. The S-SSB repetition module 608 may transmit one or more additional S-SSBs to the second UE in one or more additional subsets of the bandwidth. In some aspects, the one or more additional S-SSBs may comprise at least one of a second sequence shift different from the first sequence shift or a second identifier associated with the first UE different from the first identifier associated with the first UE.

In some aspects, the S-SSB repetition module 608 of a first UE (e.g., the UE 115 or 600) may receive a first sidelink synchronization block (S-SSB) from a second UE (e.g., the UE 115 or 600) in a first subset of a bandwidth, wherein the first S-SSB comprises a first sequence shift and a first identifier associated with the second UE. The S-SSB repetition module 608 may receive one or more additional S-SSBs from the second UE in one or more additional subsets of the bandwidth. In some aspects, the one or more additional S-SSBs may comprise at least one of a second sequence shift different from the first sequence shift or a second identifier associated with the second UE different from the first identifier associated with the second UE.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

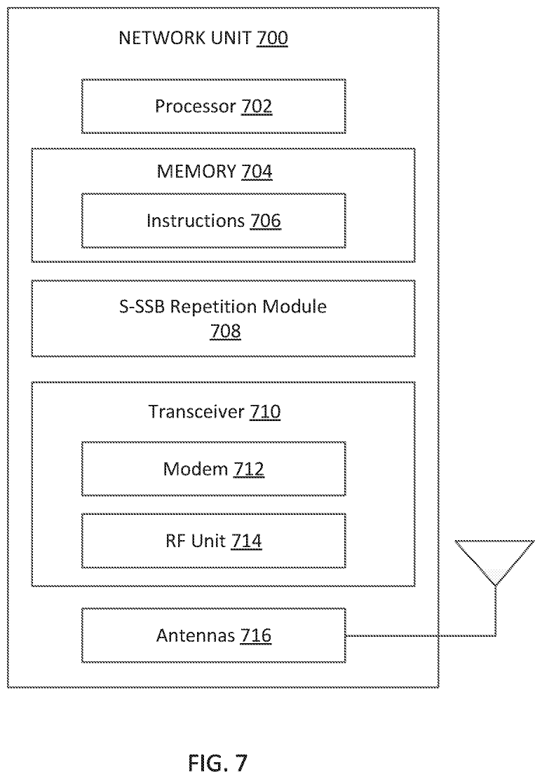

FIG. 7 is a block diagram of an exemplary network unit 700 according to some aspects of the present disclosure. The network unit 700 may be the BS 105, the CU 210, the DU 230, or the RU 240, as discussed above. As shown, the network unit 700 may include a processor 702, a memory 704, a S-SSB repetition module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 3-5. Instructions 706 may also be referred to as code, which may be interpreted broadly to include any type of computer-readable statement(s).

The S-SSB repetition module 708 may be implemented via hardware, software, or combinations thereof. For example, the S-SSB repetition module 708 may be implemented as a processor, circuit, and/or instructions 706 stored in the memory 704 and executed by the processor 702.

In some aspects, the S-SSB repetition module 708 may implement the aspects of FIGS. 3-5. For example, the S-SSB repetition module 708 may transmit, to a sidelink UE, a configuration associated with S-SSB repetition in a wide bandwidth. Additionally or alternatively, the S-SSB repetition module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

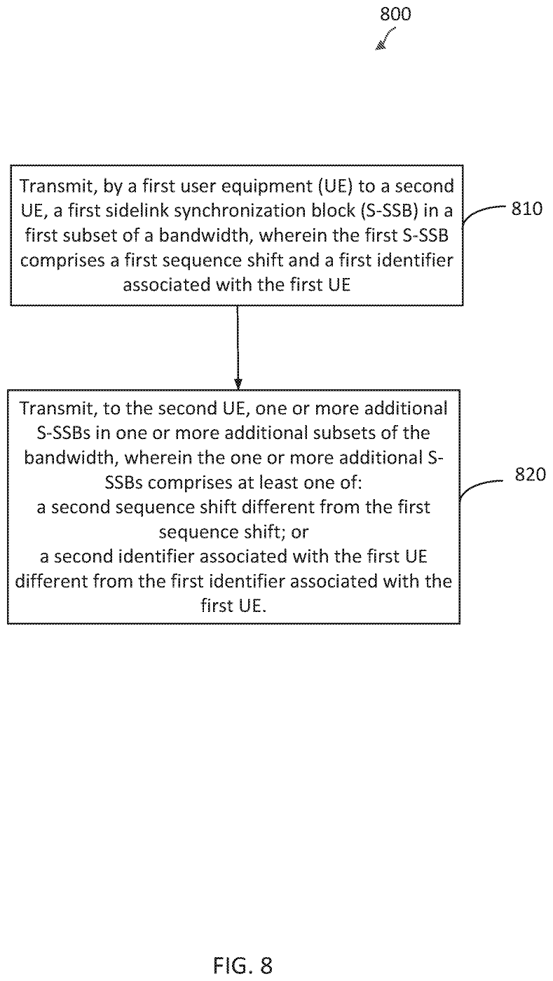

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the actions. For example, a wireless communication device, such as the UE 115 or the UE 600, may utilize one or more components, such as the processor 602, the memory 604, the S-SSB repetition module 808, the transceiver 610, the modem 612, and the one or more antennas 616, to execute aspects of method 800. The method 800 may employ similar mechanisms as in the networks 100 and 200 and the aspects and actions described with respect to FIGS. 3-5. As illustrated, the method 800 includes a number of enumerated actions, but the method 800 may include additional actions before, after, and in between the enumerated actions. In some aspects, one or more of the enumerated actions may be omitted or performed in a different order.

At action 810, the method 800 includes a first UE (e.g., the UE 115 or the UE 600) transmitting a first sidelink synchronization block (S-SSB) to a second UE (e.g., the UE 115 or the UE 600). In this regard, the first UE may transmit the first S-SSB to the second UE in a first subset of a bandwidth. The bandwidth may include a 20 MHz bandwidth, a 40 MHz bandwidth, an 80 MHz bandwidth, or other suitable bandwidth. In some aspects, the bandwidth may be in an unlicensed band (e.g., a shared band). The subset of the bandwidth may include a 5 MHz bandwidth part, a 10 MHz bandwidth part, or any suitable bandwidth part. In some aspects, the subset of the bandwidth may include one or more guard bands.

The first S-SSB may include a sidelink primary synchronization signal (SPSS), a sidelink secondary synchronization signal (SSSS), and a physical sidelink broadcast channel (PSBCH). The first UE may be a sidelink syncref UE. The second UE may decode the S-SSB to determine a sidelink synchronization identity associated with the first UE and synchronize timing to the first UE. In some aspects, there may be 672 unique physical layer sidelink synchronization identities for the first UE given by N_{ID}^{SL}=N_{ID,1}^{SL}+336N_{ID,2}^{SL}, where N_{ID,1}^{SL}∈{0,1, . . . ,335} and N_{ID,2}^{SL}∈{0,1}.

In some aspects, the sequence for the SPSS may include at least one of a Gold sequence or at least one m-sequence. In some aspects, the SPSS may be defined by d_{S-PSS}(n)=1−2x(m), m=(n+22 +43_{ID,2}^{SL}) mod 127 and 0≤n<127, where x(i+7)=(x(i+4)+x(i)) mod 2 and [x(6) x(5) x(4) x(3) x(2) x(1) x(0)]=[1 1 1 0 1 1 0]. In some aspects, the second UE may decode the SPSS of the first S-SSB. The SPSS may indicate one out of two identities (e.g., 0 or 1) for (N_{ID,2}^{SL}) associated with the first UE.

In some aspects, the sequence for the SSSS may include at least one of a Gold sequence or at least one m-sequence. In some aspects, the SSSS may be defined by d_{S-SSS}(n)=[1−2x₀((n+m₀) mod 127)] [1−2x₁((n+m₁) mod 127)],

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112 and 0 \leq n < 127 ,$$

where x₀(i+7)=(x₀(i+4)+x₀(i)) mod 2 and x₁(i+7)=(x₁(i+1)+x₁(i)) mod 2, where: [x₀(6) x₀(5) x₀(4) x₀(3) x₀(2) x₀(1) x₀(0)]=[0 0 0 0 0 0 1] and [x₁(6) x₁(5) x₁(4) x₁(3) x₁(2) x₁(1) x₁(0)]=[0 0 0 0 0 0 1]

In some aspects, the first S-SSB may include a first sequence shift (e.g., a legacy sequence shift according to 3GPP release 16). The first S-SSB may include a legacy N_{ID}^{SL} to determine the unique physical layer sidelink synchronization identity for the first UE. The first UE may transmit the first S-SSB in a first subset of the bandwidth. The first subset of the bandwidth may be a bandwidth part (e.g., a 5 MHz bandwidth part) located at a lower portion (e.g., lower edge) of the bandwidth. In some aspects, the first subset of the bandwidth may overlap a first sync raster of the bandwidth. For example, a center portion of the first subset of the bandwidth may overlap a center portion of the sync raster.

At action 820, the method 800 includes the first UE transmitting one or more additional S-SSBs in one or more additional subsets of the bandwidth to the second UE. In this regard, the first UE may transmit one, two, three, or more additional S-SSB(s) in one or more additional subsets of the bandwidth. The additional S-SSB(s) may include a second sequence shift different from the first sequence shift and/or a second identifier associated with the first UE different from the first identifier associated with the first UE. In some aspects, the additional subset(s) of the bandwidth may be bandwidth part(s) (e.g., 5 MHz bandwidth part(s)) located anywhere in the bandwidth other than the first subset of the bandwidth. For example, the first subset may be a bandwidth part located at a lower portion of the bandwidth while the additional subset(s) may be located higher than the first subset. The first subset and the additional subset(s) may not overlap in frequency. In some aspects, the first subset of the bandwidth may overlap a first sync raster of the bandwidth and the additional subset(s) of the bandwidth may not overlap additional sync raster of the bandwidth. In some aspects, the first subset and the additional subset(s) may be equally spaced within the bandwidth. A guard band may be located between the first subset and the additional subset(s). In some aspects, the first UE may transmit the additional S-SSB(s) in additional subset(s) of the bandwidth in order to satisfy an occupied channel bandwidth (OCB) requirement (e.g., 80% of a 20 MHz band).

In some aspects, the first UE may transmit the additional S-SSB(s) in additional subset(s) of the bandwidth based on the additional S-SSB(s) having a second sequence shift different from the first sequence shift used in transmitting the first S-SSB. The first UE may transmit the additional S-SSB(s) with the second sequence shift different from the first sequence shift in order to reduce a peak-to-average power ratio (PAPR) associated with transmitting multiple S-SSBs across the bandwidth. In this regard, the first SPSS sequence may include the legacy SPSS sequence, m=(n+22+43N_{ID,2}^{SL}) mod 127. However, for i additional S-SSB(s), the additional SPSSs ith frequency copy, m may be modified to be a function of the ‘i’. For example, m=(n+22+f(i)+43N_{ID,2}^{SL}. mod 127 where 1≤i<N. In some aspects, f(i) may be chosen such that (n+22+f(i) 30 43N_{ID,2}^{SL}) mod 127 is different from legacy m=(n+22+43N_{ID,2}^{SL}) mod 127. For example, the function f(i) may avoid choosing a multiple of 43.

Additionally or alternatively, the first UE may transmit the additional S-SSB(s) in additional subset(s) of the bandwidth based on a second identifier N_{ID,2}^{SL} different from a first identifier N_{ID,2}^{SL} (e.g., legacy identifier) used for transmitting the SPSS in the first S-SSB. For example, in the first S-SSB, the legacy SPSS sequence may be used, m=(n+22+43N_{ID,2}^{SL}) mod 127. However, for i additional S-SSB(s), the additional SPSSs ith frequency copy, a different N_{ID,2}^{SL}(i) is chosen. For example, m=(n+22+43N_{ID,2}^{SL}) mod 127, where N_{ID,2}^{SL}=N_{ID,2}^{SL}+i. Therefore, the unique physical layer sidelink synchronization identity for the first UE is given by N_{ID}^{SL}=N_{ID,1}^{SL}+336N_{ID,2}^{SL}(i). In this case, the second UE receiving the additional SPSSs ith frequency copy(s) would know the value of i and therefore would be able to determine N_{ID,2}^{SL}. In some aspects, i may be an integer offset. For example, if N_{ID,2}^{SL}+i has a value of 1 and i has a value of 1, the second UE would subtract 1 from N_{ID,2}^{SL}+i to determine that Ns has a value of 0.

Additionally or alternatively, the first SSSS sequence may include the legacy SSSS sequence and the additional S-SSB(s) may include a different sequence shift. In this regard, the first SSSS sequence may include the legacy SSSS sequence, d_{S-SSS}(n)=[1−2x₀(n+m₀) mod 127)] [1−2x₁((n+m1) mod 127)], where

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112.$$

However, for i additional S-SSB(s), the additional SSSSs ith, frequency copy, m₀ may be modified to be a function of ‘i’. For example,

$${m}_{0} = 15 ⌊ \frac{{N}_{ID , 1}^{SL}}{112} ⌋ + 5 {N}_{ID , 2}^{SL} + g ( i ) ,$$

where 1≤i<N. In some aspects, g(i) may be chosen such that

$${m}_{0} = 15 ⌊ \frac{{N}_{ID , 1}^{SL}}{112} ⌋ + 5 {N}_{ID , 2}^{SL} + g ( i )$$

is different from legacy

$${m}_{0} = 15 ⌊ \frac{{N}_{ID , 1}^{SL}}{112} ⌋ + 5 {N}_{ID , 2}^{SL} .$$

For example, the function g(i) may avoid choosing a multiple of 5.

Additionally or alternatively, the first UE may transmit the additional S-SSB(s) in additional subset(s) of the bandwidth based on a second identifier N_{ID,1}^{SL} different from the first identifier N_{ID,2}^{SL} (e.g., legacy identifier) used for transmitting the SSSS in the first S-SSB. For example, for i additional S-SSB(s), the additional SSSSs ith frequency copy may include a different N_{ID,2}^{SL}(i). For example,

$${m}_{0} = 15 ⌊ \frac{{N}_{ID , 1}^{SL}}{112} ⌋ + 5 {N}_{ID , 2}^{SL} ( i ) ,$$

where 1≤i<N and where N_{ID,2}^{SL}(i)=N_{ID,2}^{SL}+i. Therefore, the unique physical layer sidelink synchronization identity for the first UE is given by N_{ID}^{SL}=N_{ID,1}^{SL}+336N_{ID,2}^{SL}(i). In this case, the second UE receiving the additional SSSSs ith frequency copy(s) would know the value of i and therefore would be able to determine N_{ID,2}^{SL}. In some aspects, i may be an integer offset. For example, if N_{ID,2}^{SL}+i has a value of 1 and i has a value of 1, the second UE would subtract 1 from N_{ID,2}^{SL}+i to determine that N_{ID,2}^{SL} has a value of 0.

Additionally or alternatively, the first UE may transmit the additional S-SSB(s) in additional subset(s) of the bandwidth based on a second physical layer sidelink synchronization identity for the first UE N_{ID}^{SL} different from the first physical layer sidelink synchronization identity for the first UE N_{ID}^{SL} (e.g., the actual first UE identifier). For example, a circular shift in x₁(n) and x₀(n) of the SSSS sequence d_{S-SSS}(n)=[1−2x₀((n+m₀) mod 127)] [1−2x₁((n+m₁) mod 127)] may determine the second physical layer sidelink synchronization identity for the first UE N_{ID}^{SL}. In some aspects, the second UE may decode and combine the first S-SSB and the additional S-SSB(s).

In some aspects, the second physical layer sidelink synchronization identity for the first UE N_{ID}^{SL} may be an integer offset from the first physical layer sidelink synchronization identity for the first UE N_{ID}^{SL} (e.g., the actual first UE identifier). In this case, the second UE receiving the additional S-SSBs would know the value of the offset and therefore would be able to determine the actual physical layer sidelink synchronization identity for the first UE N_{ID}^{SL}.

Additionally or alternatively, the first UE may transmit the additional S-SSB(s) in additional subset(s) of the bandwidth based on a second physical layer sidelink synchronization identity for the first UE N_{ID}^{SL} different from the first physical layer sidelink synchronization identity for the first UE N_{ID}^{SL} (e.g., the actual first UE identifier). For example, an initialization value (e.g., an initial scrambling seed) for an i-th frequency repetition of the additional S-SSB(s) in additional subset(s) of the bandwidth may be expressed as cᵢₙᵢₜ=f(N_{ID}^{SL}, (i)) (e.g., instead of the unmodified initialization value of cᵢₙᵢₜ=N_{SL}^{ID}). In cases involving modification of the initialization variable for scrambling the additional S-SSB(s), a different No may result in the sequence shift in x₀ or/and x₁ in the SSSS of the additional S-SSB(s).

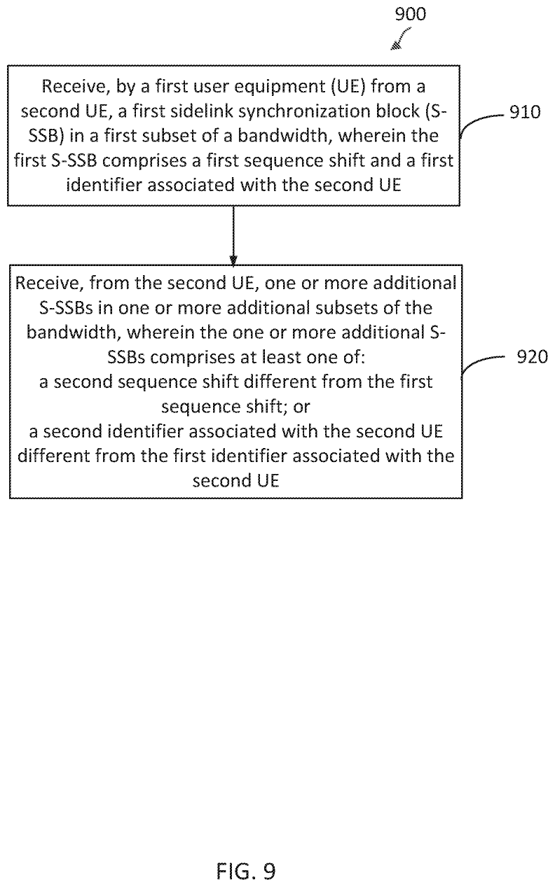

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the actions. For example, a wireless communication device, such as the UE 115 or the UE 600, may utilize one or more components, such as the processor 602, the memory 604, the S-SSB repetition module 608, the transceiver 610, the modem 612, and the one or more antennas 616, to execute aspects of method 900. The method 900 may employ similar mechanisms as in the networks 100 and 200 and the aspects and actions described with respect to FIGS. 3-5. As illustrated, the method 900 includes a number of enumerated actions, but the method 900 may include additional actions before, after, and in between the enumerated actions. In some aspects, one or more of the enumerated actions may be omitted or performed in a different order.

At action 910, the method 900 includes a first UE (e.g., the UE 115 or the UE 600) receiving a first sidelink synchronization block (S-SSB) from a second UE (e.g., the UE 115 or the UE 600). In this regard, the first UE may receive the first S-SSB from the second UE in a first subset of a bandwidth. The bandwidth may include a 20 MHz bandwidth, a 40 MHz bandwidth, an 80 MHz bandwidth, or other suitable bandwidth. In some aspects, the bandwidth may be in an unlicensed band (e.g., a shared band). The subset of the bandwidth may include a 5 MHz bandwidth part, a 10 MHz bandwidth part, or any suitable bandwidth part. In some aspects, the subset of the bandwidth may include one or more guard bands.

The first S-SSB may include a sidelink primary synchronization signal (SPSS), a sidelink secondary synchronization signal (SSSS), and a physical sidelink broadcast channel (PSBCH). The second UE may be a sidelink syncref UE. The first UE may decode the S-SSB to determine a sidelink synchronization identity associated with the second UE and synchronize timing to the second UE. In some aspects, there may be 672 unique physical layer sidelink synchronization identities for the second UE given by N_{ID}^{SL}=N_{ID,1}^{SL}+336N_{ID,2}^{SL}, where N_{ID,1}^{SL}∈{0,1, . . . ,335} and N_{ID,2}^{SL}∈{0,1}.

In some aspects, the sequence for the SPSS may include at least one of a Gold sequence or at least one m-sequence. In some aspects, the SPSS may be defined by d_{S-PSS}(n)=1−2x(m), m=(n+22+43N_{ID,2}^{SL}) mod 127 and 0≤n<127, where x(i+7)=(x(i+4)+x(i)) mod 2 and [x(6) x(5) x(4) x(3) x(2) x(1) x(0)]=[1 1 1 0 1 1 0]. In some aspects, the first UE may decode the SPSS of the first S-SSB. The SPSS may indicate one out of two identities (e.g., 0 or 1) for (N_{ID,2}^{SL}) associated with the second UE.

In some aspects, the sequence for the SSSS may include at least one of a Gold sequence or at least one m-sequence. In some aspects, the SSSS may be defined by d_{S-SSS}(n)=[1−2x₀((n+m₀) mod 127)] [1−2x₁((n+m₁) mod 127)].

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112 and 0 \leq n < 127 ,$$

where x₀(i+7)=(x₀(i+4)+x₀(i)) mod 2 and x₁(i+7)=(x₁(i+1)+x₁(i)) mod 2, where:
[x₀(6) x₀(5) x₀(4) x₀(3) x₀(2) x₀(1) x₀(0)]=[0 0 0 0 0 0 1] and [x₁(6) x₁(5) x₁(4) x₁(3) x₁(2) x₁(1) x₁(0)]=[0 0 0 0 0 0 1]

In some aspects, the first S-SSB may include a first sequence shift (e.g., a legacy sequence shift according to 3GPP release 16). The first S-SSB may include a legacy N_{ID}^{SL} to determine the unique physical layer sidelink synchronization identity for the second UE. The first UE may receive the first S-SSB in a first subset of the bandwidth. The first subset of the bandwidth may be a bandwidth part (e.g., a 5 MHz bandwidth part) located at a lower portion (e.g., lower edge) of the bandwidth. In some aspects, the first subset of the bandwidth may overlap a first sync raster of the bandwidth. For example, a center portion of the first subset of the bandwidth may overlap a center portion of the sync raster.

At action 920, the method 900 includes the first UE receiving one or more additional S-SSBs in one or more additional subsets of the bandwidth from the second UE. In this regard, the first UE may receive one, two, three, or more additional S-SSB(s) in one or more additional subsets of the bandwidth. The additional S-SSB(s) may include a second sequence shift different from the first sequence shift and/or a second identifier associated with the second UE different from the first identifier associated with the second UE. In some aspects, the additional subset(s) of the bandwidth may be bandwidth part(s) (e.g., 5 MHz bandwidth part(s)) located anywhere in the bandwidth other than the first subset of the bandwidth. For example, the first subset may be a bandwidth part located at a lower portion (e.g., lower edge) of the bandwidth while the additional subset(s) may be located higher than the first subset. The first subset and the additional subset(s) may not overlap in frequency. In some aspects, the first subset of the bandwidth may overlap a first sync raster of the bandwidth and the additional subset(s) of the bandwidth may not overlap additional sync raster of the bandwidth. In some aspects, the first subset and the additional subset(s) may be equally spaced within the bandwidth. A guard band may be located between the first subset and the additional subset(s). In some aspects, the first UE may receive the additional S-SSB(s) in additional subset(s) of the bandwidth in order to satisfy an occupied channel bandwidth (OCB) requirement (e.g., 80% of a 20 MHz band).

In some aspects, the first UE may receive the additional S-SSB(s) in additional subset(s) of the bandwidth based on the additional S-SSB(s) having a second sequence shift different from the first sequence shift used in receiving the first S-SSB. The first UE may receive the additional S-SSB(s) with the second sequence shift different from the first sequence shift in order to reduce a peak-to-average power ratio (PAPR) associated with the second UE transmitting multiple S-SSBs across the bandwidth. In this regard, the first SPSS sequence may include the legacy SPSS sequence, m=(n+22+43N_{ID,2}^{SL}) mod 127. However, for i additional S-SSB(s), the additional SPSSs ith frequency copy, m may be modified to be a function of the ‘i’. For example, m=(n+22+f(i)+43N_{ID,2}^{SL}) mod 127 where 1≤i<N. In some aspects, f(i) may be chosen such that (n+22+f(i)+43N_{ID,2}^{SL}) mod 127 is different from legacy m=(n+22+43N_{ID,2}^{SL}) mod 127. For example, the function f(i) may avoid choosing a multiple of 43.

Additionally or alternatively, the first UE may receive the additional S-SSB(s) in additional subset(s) of the bandwidth based on a second identifier N_{ID,2}^{SL} different from a first identifier N_{ID,2}^{SL} (e.g., legacy identifier) used by the second UE for transmitting the SPSS in the first S-SSB. For example, in the first S-SSB, the legacy SPSS sequence may be used, m=(n+22+43N_{ID,2}^{SL}) mod 127. However, for i additional S-SSB(s), the additional SPSSs ith frequency copy, a different N_{ID,2}^{SL}(i) is chosen. For example, m=(n+22+43N_{ID,2}^{SL} mod 127, where N_{ID,2}^{SL}(i)=N_{ID,2}^{SL}+i. Therefore, the unique physical layer sidelink synchronization identity for the second UE is given by N_{ID,}^{SL}=N_{ID,1}^{SL}+336N_{ID,2}^{SL}(i). In this case, the first UE receiving the additional SPSSs ith frequency copy(s) would know the value of i and therefore would be able to determine N_{ID,2}^{SL}. In some aspects, i may be an integer offset. For example, if N_{ID,2}^{SL}+i has a value of 1 and i has a value of 1, the second UE would subtract 1 from N_{ID,2}^{SL}+i to determine that N_{ID,2}^{SL} has a value of 0.

Additionally or alternatively, the first SSSS sequence may include the legacy SSSS sequence and the additional S-SSB(s) may include a different sequence shift. In this regard, the first SSSS sequence may include the legacy SSSS sequence, d_{S-SSS}(n)=[1−2x₀((n+m₀) mod 127)] [1−2x₁((n+m₁) mod 127)], where

$${m}_{0} = 15 ⌊ \frac{{N}_{ID , 1}^{SL}}{112} ⌋ + 5 {N}_{ID , 2}^{SL} and {m}_{1} = {N}_{ID , 1}^{SL} mod 112.$$

However, for i additional S-SSB(s), the additional SSSSs ith frequency copy, m₀ may be modified to be a function of ‘i’. For example,

$${m}_{0} = 15 ⌊ \frac{{N}_{ID , 1}^{SL}}{112} ⌋ + 5 {N}_{ID , 2}^{SL} + g ( i ) ,$$

where 1≤i<N. In some aspects, g(i) may be chosen such that

$${m}_{0} = 15 ⌊ \frac{{N}_{ID , 1}^{SL}}{112} ⌋ + 5 {N}_{ID , 2}^{SL} + g ( i )$$

is different from legacy

$${m}_{0} = 15 ⌊ \frac{{N}_{ID , 1}^{SL}}{112} ⌋ + 5 {N}_{ID , 2}^{SL} .$$

For example, the function g(i) may avoid choosing a multiple of 5.

Additionally or alternatively, the first UE may receive the additional S-SSB(s) in additional subset(s) of the bandwidth based on a second identifier N_{ID,2}^{SL} different from the first identifier N_{ID,2}^{SL} (e.g., legacy identifier) used by the second UE for transmitting the SSSS in the first S-SSB. For example, for i additional S-SSB(s), the additional SSSSs ith frequency copy may include a different N_{ID,2}^{SL}(i). For example,

$${m}_{0} = 15 ⌊ \frac{{N}_{ID , 1}^{SL}}{112} ⌋ + 5 {N}_{ID , 2}^{SL} ( i ) ,$$

where 1≤i<N and where N_{ID,2}^{SL}(i)=N_{ID,2}^{SL}+i. Therefore, the unique physical layer sidelink synchronization identity for the second UE is given by N_{ID}^{SL}=N_{ID,1}^{SL}+336N_{ID,2}^{SL}(i). In this case, the first UE receiving the additional SSSSs ith frequency copy(s) would know the value of i and therefore would be able to determine N_{ID,2}^{SL}. In some aspects, i may be an integer offset. For example, if N_{ID,2}^{SL}+i has a value of 1 and i has a value of 1, the second UE would subtract 1 from N_{ID,2}^{SL}+i to determine that N_{ID,2}^{SL} has a value of 0.

Additionally or alternatively, the first UE may receive the additional S-SSB(s) i n additional subset(s) of the bandwidth based on a second physical layer sidelink synchronization identity for the second UE N_{ID}^{SL} different from the first physical layer sidelink synchronization identity for the second UE N_{ID}^{SL} (e.g., the actual second UE identifier). For example, a circular shift in x₁(n) and x₀(n) of the SSSS sequence d_{S-SSS}(n)=[1−2x₀((n+m₀) mod 127)] [1−2x₁((n+m₁) mod 127)] may determine the second physical layer sidelink synchronization identity for the second UE N_{ID}^{SL}. In some aspects, the first UE may decode and combine the first S-SSB and the additional S-SSB(s).

In some aspects, the second physical layer sidelink synchronization identity for the second UE N_{ID}^{SL} may be an integer offset from the first physical layer sidelink synchronization identity for the second UE N_{ID}^{SL} (e.g., the actual second UE identifier). In this case, the first UE receiving the additional S-SSBs would know the value of the offset and therefore would be able to determine the actual physical layer sidelink synchronization identity for the second UE N_{ID}^{SL}.

Additionally or alternatively, the first UE may receive the additional S-SSB(s) in additional subset(s) of the bandwidth based on a second physical layer sidelink synchronization identity for the second UE N_{ID}^{SL} different from the first physical layer sidelink synchronization identity for the second UE N_{ID}^{SL} (e.g., the actual second UE identifier). For example, an initialization value (e.g., an initial scrambling seed) for an i-th frequency repetition of the additional S-SSB(s) in additional subset(s) of the bandwidth may be expressed as cᵢₙᵢₜ=f(N_{ID}^{SL}, (i)) (e.g., instead of the unmodified initialization value of cᵢₙᵢₜ=N_{SL}^{ID}). In cases involving modification of the initialization variable for scrambling the additional S-SSB(s), a different N_{ID}^{SL} may result in a sequence shift in x₀ and/or x₁ in the SSSS of the additional S-SSB(s).

Further aspects of the present disclosure include the following:
Aspect 1 includes a method of wireless communication performed by a first user equipment (UE), the method comprising transmitting, to a second UE, a first sidelink synchronization block (S-SSB) in a first subset of a bandwidth, wherein the first S-SSB comprises a first sequence shift and a first identifier associated with the first UE; and transmitting, to the second UE, one or more additional S-SSBs in one or more additional subsets of the bandwidth, wherein the one or more additional S-SSBs comprises at least one of a second sequence shift different from the first sequence shift; or a second identifier associated with the first UE different from the first identifier associated with the first UE.
Aspect 2 includes the method of aspect 1, wherein the first sequence shift comprises a sequence shift to a sidelink primary synchronization signal (SPSS) of the first S-SSB.
Aspect 3 includes the method of any of aspects 1-2, wherein the SPSS comprises at least one of a Gold sequence or at least one m-sequence.
Aspect 4 includes the method of any of aspects 1-3, wherein the first sequence shift comprises a sequence shift to a sidelink secondary synchronization signal (SSSS) of the first S-SSB.
Aspect 5 includes the method of any of aspects 1-4, wherein the SSSS comprises at least one of a Gold sequence or at least one m-sequence.
Aspect 6 includes the method of any of aspects 1-5, wherein the one or more additional S-SSBs comprises the second sequence shift; and the one or more additional S-SSBs further comprises a third sequence shift different from the first sequence shift and the second sequence shift.
Aspect 7 includes the method of any of aspects 1-6, wherein the second sequence shift is associated with a first pseudo noise (PN) sequence and the third sequence shift is associated with a second PN sequence.
Aspect 8 includes the method of any of aspects 1-7, wherein the second identifier associated with the first UE comprises an integer offset from the first identifier associated with the first UE.
Aspect 9 includes the method of any of aspects 1-8, wherein the second identifier associated with the first UE comprises an integer multiple of the first identifier associated with the first UE.
Aspect 10 includes the method of any of aspects 1-9, wherein the one or more additional S-SSBs comprises a sidelink secondary synchronization signal (SSSS); and the second sequence shift comprises a circular shift.
Aspect 11 includes the method of any of aspects 1-10, wherein the one or more additional S-SSBs further comprises a physical sidelink broadcast channel (PSBCH) communication; and an initial scrambling seed of the PSBCH communication is based on a third identifier associated with the first UE.
Aspect 12 includes the method of any of aspects 1-11, wherein at least one of the bandwidth comprises a 20 MHz bandwidth; or the one or more additional subsets of the bandwidth comprises at least one of one additional subset, two additional subsets, or three additional subsets of the bandwidth
Aspect 13 includes the method of any of aspects 1-12, wherein the first subset of the bandwidth overlaps a first sync raster of the bandwidth; and the one or more additional subsets of the bandwidth do not overlap a second sync raster of the bandwidth
Aspect 14 includes a method of wireless communication performed by a first user equipment (UE), the method comprising receiving, from a second UE, a first sidelink synchronization block (S-SSB) in a first subset of a bandwidth, wherein the first S-SSB comprises a first sequence shift and a first identifier associated with the second UE; and receiving, from the second UE, one or more additional S-SSBs in one or more additional subsets of the bandwidth, wherein the one or more additional S-SSBs comprises at least one of a second sequence shift different from the first sequence shift; or a second identifier associated with the second UE different from the first identifier associated with the second UE.
Aspect 15 includes the method of aspect 14, wherein the first sequence shift comprises a sequence shift to a sidelink primary synchronization signal (SPSS) of the first S-SSB.
Aspect 16 includes the method of any of aspects 14-15, wherein the SPSS comprises at least one of a Gold sequence or at least one m-sequence.
Aspect 17 includes the method of any of aspects 14-16, wherein the first sequence shift comprises a sequence shift to a sidelink secondary synchronization signal (SSSS) of the first S-SSB.
Aspect 18 includes the method of any of aspects 14-17, wherein the SSSS comprises at least one of a Gold sequence or at least one m-sequence.
Aspect 19 includes the method of any of aspects 14-18, wherein he one or more additional S-SSBs comprises the second sequence shift; and the one or more additional S-SSBs further comprises a third sequence shift different from the first sequence shift and the second sequence shift.
Aspect 20 includes the method of any of aspects 14-19, wherein the second sequence shift is associated with a first pseudo noise (PN) sequence and the third sequence shift is associated with a second PN sequence.
Aspect 21 includes the method of any of aspects 14-20, wherein the second identifier associated with the second UE comprises an integer offset from the first identifier associated with the second UE.
Aspect 22 includes the method of any of aspects 14-21, wherein the second identifier associated with the second UE comprises an integer multiple of the first identifier associated with the second UE.
Aspect 23 includes the method of any of aspects 14-22, wherein the one or more additional S-SSBs comprises a sidelink secondary synchronization signal (SSSS); and the second sequence shift comprises a circular shift.
Aspect 24 includes the method of any of aspects 14-23, wherein the one or more additional S-SSBs further comprises a physical sidelink broadcast channel (PSBCH) communication; and an initial scrambling seed of the PSBCH communication is based on a third identifier associated with the second UE.
Aspect 25 includes the method of any of aspects 14-24, wherein at least one of: the bandwidth comprises a 20 MHz bandwidth; or the one or more additional subsets of the bandwidth comprises at least one of one additional subset, two additional subsets, or three additional subsets of the bandwidth.
Aspect 26 includes the method of any of aspects 14-25, wherein the first subset of the bandwidth overlaps a first sync raster of the bandwidth; and the one or more additional subsets of the bandwidth do not overlap a second sync raster of the bandwidth.
Aspect 27 includes a non-transitory computer-readable medium storing one or more instructions for wireless communication, the one or more instructions comprising one or more instructions that, when executed by one or more processors of a first UE perform any one of aspects 1-13.
Aspect 28 includes a non-transitory computer-readable medium storing one or more instructions for wireless communication, the one or more instructions comprising one or more instructions that, when executed by one or more processors of a first UE, cause the first UE to perform any one of aspects 14-26.
Aspect 29 includes a first UE comprising one or more means to perform any one or more of aspects 1-13.
Aspect 30 includes a first UE comprising one or more means to perform any one or more of aspects 14-26.
Aspect 31 includes a first UE comprising a memory; a transceiver; and at least one processor coupled to the memory and the transceiver, wherein the first UE is configured to perform any one or more of aspects 1-13.
Aspect 32 includes a first UE comprising a memory; a transceiver; and at least one processor coupled to the memory and the transceiver, wherein the first UE is configured to perform any one or more of aspects 14-26.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a first user equipment, the method comprising:
transmitting, to a second UE, a first sidelink synchronization block (S-SSB) in a first subset of a bandwidth, wherein the first S-SSB comprises a first sequence shift and a first identifier associated with the first UE; and
transmitting, to the second UE, one or more additional S-SSBs in one or more additional subsets of the bandwidth, wherein the one or more additional S-SSBs comprises at least one of:
a second sequence shift different from the first sequence shift; or
a second identifier associated with the first UE different from the first identifier associated with the first UE.

2. The method of claim 1, wherein:
the first sequence shift comprises a sequence shift to a sidelink primary synchronization signal (SPSS) of the first S-SSB; and
the SPSS comprises at least one of a Gold sequence or at least one m-sequence.

3. The method of claim 1, wherein:
the first sequence shift comprises a sequence shift to a sidelink secondary synchronization signal (SSSS) of the first S-SSB; and
the SSSS comprises at least one of a Gold sequence or at least one m-sequence.

4. The method of claim 1, wherein:
the one or more additional S-SSBs comprises the second sequence shift;
the one or more additional S-SSBs further comprises a third sequence shift different from the first sequence shift and the second sequence shift; and
the second sequence shift is associated with a first pseudo noise (PN) sequence and the third sequence shift is associated with a second PN sequence.

5. The method of claim 1, wherein the second identifier associated with the first UE comprises an integer offset from the first identifier associated with the first UE.

6. The method of claim 1, wherein the second identifier associated with the first UE comprises an integer multiple of the first identifier associated with the first UE.

7. The method of claim 1, wherein:
the one or more additional S-SSBs comprises a sidelink secondary synchronization signal (SSSS); and
the second sequence shift comprises a circular shift.

8. The method of claim 1, wherein:
the one or more additional S-SSBs further comprises a physical sidelink broadcast channel (PSBCH) communication; and
an initial scrambling seed of the PSBCH communication is based on a third identifier associated with the first UE.

9. The method of claim 1, wherein at least one of:
the bandwidth comprises a 20 MHz bandwidth; or
the one or more additional subsets of the bandwidth comprises at least one of one additional subset, two additional subsets, or three additional subsets of the bandwidth.

10. The method of claim 1, wherein:
the first subset of the bandwidth overlaps a first sync raster of the bandwidth; and
the one or more additional subsets of the bandwidth do not overlap a second sync raster of the bandwidth.

11. A first user equipment (UE) comprising:
a memory;
a transceiver; and
at least one processor coupled to the memory and the transceiver, wherein the at least one processor is configured, alone or in any combination, to cause the first UE to:
transmit, to a second UE, a first sidelink synchronization block (S-SSB) in a first subset of a bandwidth, wherein the first S-SSB comprises a first sequence shift and a first identifier associated with the first UE; and
transmit, to the second UE, one or more additional S-SSBs in one or more additional subsets of the bandwidth, wherein the one or more additional S-SSBs comprises at least one of:
a second sequence shift different from the first sequence shift; or
a second identifier associated with the first UE different from the first identifier associated with the first UE.

12. The first UE of claim 11, wherein:
the first sequence shift comprises a sequence shift to a sidelink primary synchronization signal (SPSS) of the first S-SSB; and
the SPSS comprises at least one of a Gold sequence or at least one m-sequence.

13. The first UE of claim 11, wherein:
the first sequence shift comprises a sequence shift to a sidelink secondary synchronization signal (SSSS) of the first S-SSB; and
the SSSS comprises at least one of a Gold sequence or at least one m-sequence.

14. The first UE of claim 11, wherein:
the one or more additional S-SSBs comprises the second sequence shift;
the one or more additional S-SSBs further comprises a third sequence shift different from the first sequence shift and the second sequence shift; and
the second sequence shift is associated with a first pseudo noise (PN) sequence and the third sequence shift is associated with a second PN sequence.

15. The first UE of claim 11, wherein the second identifier associated with the first UE comprises an integer offset from the first identifier associated with the first UE.

16. The first UE of claim 11, wherein the second identifier associated with the first UE comprises an integer multiple of the first identifier associated with the first UE.

17. The first UE of claim 11, wherein:
the one or more additional S-SSBs comprises a sidelink secondary synchronization signal (SSSS); and
the second sequence shift comprises a circular shift.

18. The first UE of claim 11, wherein:
the one or more additional S-SSBs further comprises a physical sidelink broadcast channel (PSBCH) communication; and
an initial scrambling seed of the PSBCH communication is based on a third identifier associated with the first UE.

19. The first UE of claim 11, wherein at least one of:
the bandwidth comprises a 20 MHz bandwidth; or
the one or more additional subsets of the bandwidth comprises at least one of one additional subset, two additional subsets, or three additional subsets of the bandwidth.

20. The first UE of claim 11, wherein:
the first subset of the bandwidth overlaps a first sync raster of the bandwidth; and
the one or more additional subsets of the bandwidth do not overlap a second sync raster of the bandwidth.
